(19) United States
(12) Patent Application Publication
(10) Pub. No.: US 2009/0251460 A1
(43) Pub. Date: Oct. 8, 2009

(54) Systems and methods for incorporating reflection of a user and surrounding environment into a graphical user interface

(75) Inventor: Anthony Dunnigan, Berkeley, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/080,675

(22) Filed: Apr. 4, 2008

(51) Int. Cl. G06T 15/50; G09G 5/00

(52) U.S. Cl. 345/419; 345/619; 345/649; 345/660; 345/672; 345/647; 345/632; 345/589; 345/582

(57) ABSTRACT

Described are systems and methods for incorporating the reflection of a user and surrounding environment into a graphical user interface (“GUI”). The resulting reflective user interface helps merge the real world of the user with the artificial world of the computer GUI. A video of the user and the surrounding environment is taken using a video capture device such as a web camera, and the video images are manipulated to create a reflective effect that is incorporated into elements of the GUI to create a reflective user interface. The reflective effect is customized for each different element of the GUI and varies by the size, shape and material depicted in the element. The reflective effect also includes incorporation of shadows and highlights into the reflective user interface, including shadows that are responsive to simulated or actual light sources in the surrounding environment.

### BACKGROUND OF THE INVENTION

1. Field of the Invention

The present invention generally relates to systems and methods for incorporating the reflection of a user and surrounding environment into a graphical user interface, and more specifically to creating a reflective effect from a real-time video of the user and surrounding environment and incorporating the reflective effects into elements of a graphical user interface.

2. Background of the Invention

According to the Presence Hypothesis, a person's sense of presence in an environment reflects the degree to which the environment influences their perception of which objects are moving and which objects are stationary in relation to their position (Rest Frame Construct). Do Visual Background Manipulations Reduce Simulator Sickness?, Jerrold D. Prothero, Mark H. Draper, Thomas A. Furness, Donald E. Parker & Maxwell J. Wells, Human Interface Technology Laboratory, University of Washington, 1997, http://www.hypercerulean.com/documents/r-97-12.rtf. By seeing their reflection move across the surface of a static object in a user interface (in a manner that is synchronized with their actual movements) the appearance that the object is stationary is reinforced. Similarly, if an object in a user interface moves and the user's reflection is distorted appropriately their spatial relationship to that object is enhanced. A person's sense of presence influences the amount of attention that they are willing to invest in an environment, see Prothero et al. referred to hereinabove.

In his 2007 paper, Robert Putnam noted a strong tendency for people to trust other people who are more similar to them. E Pluribus Unum: Diversity and Community in the Twenty-first Century, Robert Putnam, Journal compilation, 2007, http://www.humanities.manchester.ac.uk/socialchange/aboutus/news/documents/Putnam2007.pdf. People also tend to be more cooperative with such people. In a 2007 article published in Science, Judith Donath noted that people trusted avatars that look and behave more like human beings, as apposed to androgynous avatars or those based upon non-human creatures. Virtually Trustworthy, Judith Donath, Science, 2007, http://smg.media.mit.edu/Papers/Donath/VirtuallyTrustworthy.pdf. She also noted that natural movement was important.

With respect to widely used technological devices, such as ATM machines, electronic locks or other secured systems, the incorporation of the user's reflection might discourage bad behavior. Public displays incorporating the reflections of nearby users might attract their interest, and again, might also encourage the users to behave better. In a recent study, it was observed that people behaved more honestly in the presence of cues that they were being watched even when those cues are clearly not related to any real observer. Cues of being watched enhance cooperation in a real-world setting, Melissa Bateson, Daniel Nettle, Gilbert Roberts, Evolution and Behaviour Research Group, School of Biology and Psychology. Biol. Lett., doi:10.1098/rsbl.2006.0509, 2006, http://www.staff.ncl.ac.uk/daniel.nettle/biology%20letters.pdf.

User interface (“UI”) designs have tended to become better rendered as the graphics capabilities of personal computers have increased. These UIs now depict surfaces that mimic real-world materials like brushed metal, glass or translucent plastic. Increasingly, these synthetic environments have become more three dimensional looking. However, these synthetic environments are not connected to the real-life environment surrounding the user.

In 2004, David Stotts, Jason McC. Smith, and Karl Gyllstrom developed an interface technology known as FaceTop, see Support for Distributed Pair Programming in the Transparent Video Facetop, David Stotts, Jason McC. Smith, and Karl Gyllstrom, Dept. of Computer Science, Univ. of North Carolina at Chapel Hill, 2004, http://delivery.acm.org/10.1145/1020000/1012827/p48-stotts.pdf?key1=1012827&key2=8548549811&coll=portal&dl=ACM&CFID=25432631&CFTO KEN=65578812. This interface uses motion tracking to allow users to control objects represented on their computer screens. Much of the work being done on the FaceTop deals with remote collaborations. In all cases, the video of the user used in the FaceTop UI appears as video overlays with alpha adjustments and are not meant to be naturalistic.

In 2003, Shawn Lawson's CrudeOils project produced A Bar at the Folies Bergère. A Bar at the Folies Bergère, Shawn Lawson's, CrudeOils, 2003, http://www.crudeoils.us/html/Barmaid.html. This work of art incorporated viewers' reflections into that famous painting. The figures in the painting react to the presence of the user on a flat surface in the painting. The effect of this is a “hole” in the scene that reflects the user's image but not a fully immersive scene.

The above-mentioned projects are concerned with supporting human-computer interactions by means of tracking the user's movements using real-time video analysis and real-time video feedback. It is continually desired to merge the computer interface with the real world in order to improve the user experience with the computer interface.

### SUMMARY OF THE INVENTION

The present invention relates to systems and methods for incorporating the reflection of a user and surrounding environment into a graphical user interface (“GUI”). In accordance with one aspect of the inventive methodology, a video of the user and the surrounding environment is taken using a video capture device such as a web camera, and the video images are manipulated to create a reflective effect that is incorporated into elements of the GUI to generate an inventive reflective user interface. The reflective effect is customized for each different element of the GUI and can vary by the size, shape and material depicted in the element. The reflective effect may also include incorporation of shadows and highlights into the inventive reflective user interface, including shadows that are responsive to light sources in the surrounding environment.

In accordance with one aspect of the inventive methodology, there is provided a system for incorporating a real-time reflection of a user and surrounding environment into a graphical user interface (“GUI”), the system including a video capture device for capturing a video of a user and surrounding environment in real-time; a processing module operable to receive the video from the video capture device and manipulate the video to create a reflective effect; the processing module being further operable to cause the reflective effect to be incorporated into at least one element of the GUI to create a reflective user interface; and a display operable to display the reflective user interface to the user in real-time, wherein at least a portion of the reflective effect is shown to the user.

In another aspect of the invention, the video capture device is a camera.

In another aspect of the invention, the processing module is a computer system including a memory operable to store computer-readable instructions and a processor module operable to execute the computer-readable instructions.

In another aspect of the invention, the processing module is further operable to manipulate the video by altering opacity of the video.

In another aspect of the invention, the processing module is further operable to manipulate the video by altering scale of the video.

In another aspect of the invention, the processing module is further operable to manipulate the video by altering orientation of the video.

In another aspect of the invention, the processing module is further operable to alter the orientation of the video by reversing the video image.

In another aspect of the invention, the processing module is further operable to manipulate the video by degrading quality of the video.

In another aspect of the invention, the processing module is further operable to degrade the quality of the video by blurring the video.

In another aspect of the invention, the processing module is further operable to incorporate the reflective effect into the at least one element of the GUI by overlaying the video onto the GUI using texture mapping.

In another aspect of the invention, the at least one element of the GUI comprises a window, a frame, a button or an icon.

In another aspect of the invention, the processing module is further operable to alter the reflective effect to simulate a reflection from a type of material depicted in the GUI.

In another aspect of the invention, the processing module is further operable to alter the reflective effect to simulate a reflection from a shape of the at least one element of the GUI.

In another aspect of the invention, the processing module is further operable to remove and replace the surrounding environment.

In another aspect of the invention, the processing module is further operable to incorporate the reflective user interface into a three-dimensional (“3D”) environment.

In another aspect of the invention, the processing module is further operable to import the video into the background of a scene and reflect the video into the foreground using a 3D graphics engine.

In another aspect of the invention, the display includes a computer monitor.

In another aspect of the invention, the graphical user interface includes a window, an icon, a menu, or a pointing device (“WIMP”) interface.

In another aspect of the invention, the graphical user interface includes a 3D representation of a scene.

In another aspect of the invention, the display is further operable to display the reflective user interface to a plurality of users, wherein each of the plurality of users perceives the reflective user interface differently.

In another aspect of the invention, the processing module is operable to create a reflective user interface by incorporating a shadow effect into the at least one element of the GUI.

In another aspect of the invention, the processing module is further operable to incorporate the shadow effect by identifying a light source in the surrounding environment.

In another aspect of the invention, the processing module is operable to create a reflective user interface by incorporating a highlight effect into the at least one element of the GUI.

In another aspect of the invention, the processing module is further operable to incorporate the highlight effect by identifying a light source in the surrounding environment.

In a further aspect of the inventive methodology, a method for incorporating a real-time reflection of a user and surrounding environment into a graphical user interface (“GUI”) includes: capturing a video of a user and surrounding environment in real-time; receiving the video from the video capture device; manipulating the video to create a reflective effect; incorporating the reflective effect into at least one element of the GUI to create a reflective user interface; and displaying the reflective user interface to the user in real-time, wherein at least a portion of the reflective effect is shown to the user.

In another aspect of the invention, the reflective effect is created by degrading a quality of the video.

In another aspect of the invention, the reflective effect is incorporated into a frame, a button or an icon of the GUI.

In another aspect of the invention, the reflective effect is created by incorporating a shadow effect into the at least one element of the GUI.

In a still further aspect of the inventive methodology, a computer programming product embodied on a computer readable medium and including a set of computer-readable instructions for incorporating a real-time reflection of a user and a surrounding environment into a graphical user interface (“GUI”), the set of computer-readable instructions, when executed by one or more processors, operable to cause the one or more processors to: receive a video signal of a user and surrounding environment in real-time; manipulate the video to create a reflective effect; incorporate the reflective effect into at least one element of the GUI; and generate a reflective user interface using the incorporated reflective effects.

In another aspect of the invention, the reflective effect is created by degrading a quality of the video.

In another aspect of the invention, the reflective effect is incorporated into a frame, a button or an icon of the GUI.

In another aspect of the invention, the reflective user interface is created by incorporating a shadow effect into the at least one element of the GUI.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 depicts a setup for a web camera to capture a video of a user viewing a display to create a reflective user interface, according to one aspect of the present invention;

FIG. 2 depicts a photographic illustration of a view from the web camera of the user and surrounding environment, according to one aspect of the present invention;

FIG. 3 depicts a reflective user interface simulating a mirror that can be moved within the graphical user interface (“GUI”), according to one aspect of the present invention;

FIG. 4 depicts a GUI of an digital media player application with and without the reflective user interface, according to one aspect of the present invention;

FIG. 5 depicts a GUI of a three-dimensional (“3D”) viewer application with the reflective user interface applied, according to one aspect of the present invention;

FIG. 6 depicts a 3D environment application from a point-of-view perspective as known in the art, wherein a user is provided a sense of presence with the use of an avatar;

FIG. 7 depicts a static 3D viewer application with the reflective user interface applied in a hybrid reality communication setting, where a user is given a sense of presence in the hybrid environment via the inclusion of their naturalistic reflection on various surfaces, according to one aspect of the present invention;

FIG. 8 depicts the 3D viewer application with the reflective user interface applied using projective texture mapping of an incoming video signal, according to one aspect of the present invention;

FIG. 9 depicts the 3D viewer application with the reflective user interface applied using projective texture mapping of the incoming video signal wherein the edges of the video image are stretched, according to one aspect of the present invention;

FIG. 10 depicts the process for extracting a user's image from his or her environment and placing the image into a new environment, according to one aspect of the present invention;

FIG. 11 depicts a griefing disruption in a 3D environment as known in the art;

FIG. 12 depicts a reflective user interface including a shadow effect implemented onto elements of the GUI;

FIG. 13 depicts the process used to create shadow effects and a highlight effect on the GUI elements by mapping a light source in the video; and

FIG. 14 illustrates an exemplary embodiment of a computer platform upon which the inventive system may be implemented.

### DETAILED DESCRIPTION OF THE INVENTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

An embodiment of the present invention relates to systems and methods for incorporating the reflection of a user and surrounding environment into a graphical user interface (“GUI”). In one embodiment, a video of the user and the surrounding environment is taken using a video capture device such as a web camera, and the video images are manipulated to create a reflective effect that is incorporated into elements of the GUI to generate a reflective user interface. The reflective effect is customized for each different element of the GUI and may vary by the size, shape and material depicted in the element. The generation of the reflective effect also includes incorporation of shadows and highlights into the inventive reflective user interface, including shadows that are responsive to light sources in the surrounding environment.

Including reflections of the users and their surrounding environment in accordance with one aspect of the inventive concept, results in an inventive user interface that “feels” natural. As would be appreciated by those of skill in the art, many of the surfaces, such as surfaces of many objects, that are popular in GUI designs would naturally create reflections of their environment, such as people and surrounding objects, in the real world. Such surfaces may include, without limitation, chrome, glass, brushed metal, water and the like. In the real world, people expect to see reflections on surfaces of such objects, and, to an extent, people's sense of presence depends upon seeing such reflections. By providing various visual cues to the user such as the aforesaid reflections, the inventive user interface is anchoring itself into the surrounding environment. One embodiment of the inventive system produces a user interface that features a human face, the user's own, that is looking directly at the user. The face reflection moves in a way that is completely expected and logical. In this embodiment, the inclusion of the reflection of the user's face into the GUI may simply give the user a greater sense of ownership over the underlying application, or the feeling that it was customized for the user. Further, seeing a more realistic depiction of themselves in a three-dimensional (“3D”) viewer may allow the users to empathize with the system more, as suggested by Putnam and Donath, cited above.

In one embodiment of the invention, the inventive reflective user interface incorporates naturalistic reflection of the user and the real-life environment surrounding the user in an attempt to blend real-life spaces and computer interfaces in a useful way. The goal of this embodiment of the inventive reflective user interface is to merge the real-life world of the user with the artificial world of the computer interface. The effect of this inventive merging is a more dynamic user interface that feels more customized to the user. In fact, the inventive reflective user interfaces appear substantially different depending upon the location they are viewed from because the user's surrounding environment is incorporated into the GUI. This adds to the realism of the inventive interface perceived by the user.

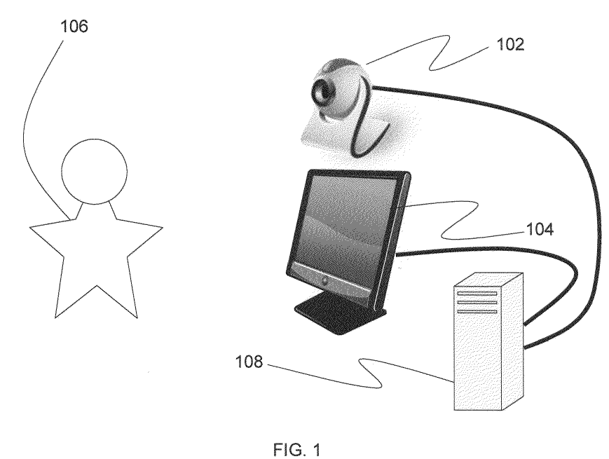

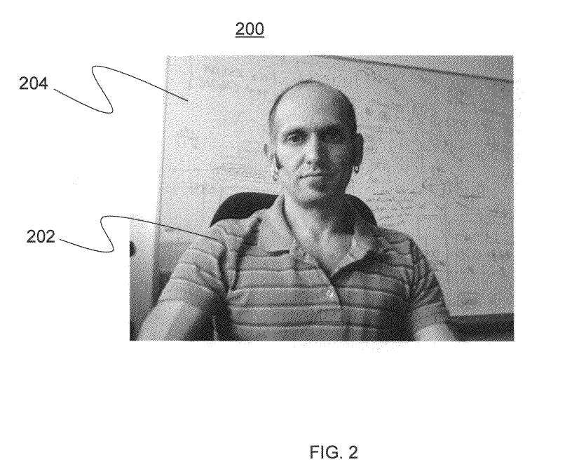

In one embodiment, the user is seated in front of a display such as a computer monitor, while a camera is positioned near the display so as to capture the user and the surrounding environment from the perspective of the display. The position of the camera 102, display 104 and user 106 are illustrated in FIG. 1, and the view 200 from the camera 102 is illustrated in FIG. 2. The view 200 includes an image of the user 202 and the surrounding environment 204.

In one embodiment of the invention, the camera 102 captures video (or multiple still images) of the user 202 and the surrounding environment 204 in real time and sends a video signal (or multiple still images) to a computer 108 connected to the display 104. In one embodiment, the computer 108 is a desktop or laptop computer with a processor and memory that is capable of carrying out computer-readable instructions. The computer 108 receives a video signal (or multiple still images) from the camera 102. In one embodiment of the invention, the video signal or multiple still images may be then processed using software developed using a multimedia authoring tool such as Adobe Flash (Adobe Systems Inc., San Jose, Calif.). A video object is created within the Flash authoring environment and is then attached to the video signal, resulting in a plurality of images. The video object is then manipulated to create a variety of reflective effects, which are then incorporated into various elements of the GUI such as buttons, windows and frames. The various ways to manipulate the video are described in further detail below. Once the reflective effects are incorporated into the GUI, a reflective user interface is created and then displayed to the user on the display 104. The video capture, manipulation and displaying of the reflective user interface are done in real-time so that the user instantly sees the reflective effects corresponding to, for example, his or her movements. The real-time displaying of the reflective user interface provides a naturalistic reflection of the user and surrounding environment that appears realistic to the user and further helps to blend the computer interface and real-life space.

One skilled in the art would appreciate that the camera 102 may be implemented using any image or video source. In addition, the image manipulation software may be implemented using a variety of different programming languages and environments, including, without limitation, Java (Sun Microsystems, Santa Clara, Calif.).

The embodiment described above does not require any signal processing, as the inventive system does not need to know anything about the incoming video signal in order to render a convincing reflective user interface. Therefore, the inventive system does not require significant computational power and is easily implemented into existing desktop or laptop computers.

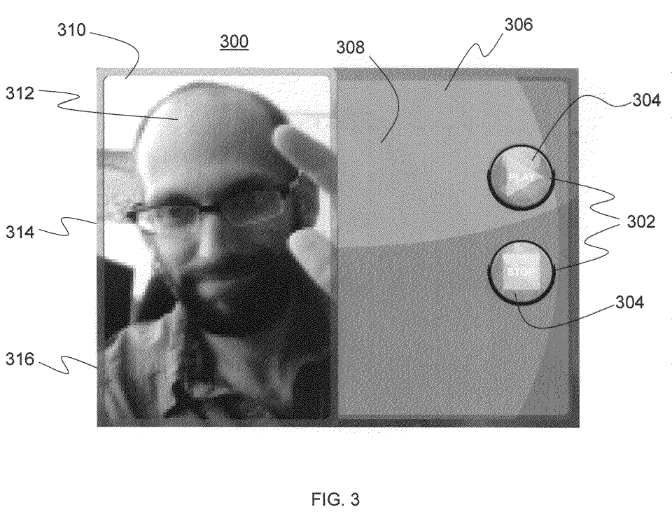

In one embodiment of the invention, all aspects of the graphical user interface (e.g. windows, buttons and frames) receive a reflective effect that is appropriate to the material that the corresponding GUI element represents. For example, in the graphical user interface 300 illustrated in FIG. 3, a spherical glass button 302 will have an appropriately distorted reflection 304, while a flat panel 306 with a matte finish will have an undistorted reflection 308 that is more transparent.

Many embodiments of the reflective user interface are possible depending on the type of GUI. In a first embodiment, illustrated in FIG. 3, a virtual mirror 310 is developed that illustrates a realistic reflective effect 312. As the mirror moves the user's spatial relationship to that virtual object is enhanced. The user watching his or her reflection pass over an object is a visual cue that the user is moving relative to the object or that the object is moving relative to the user. Additionally, the frame 314 of the application also depicts reflective effects 316.

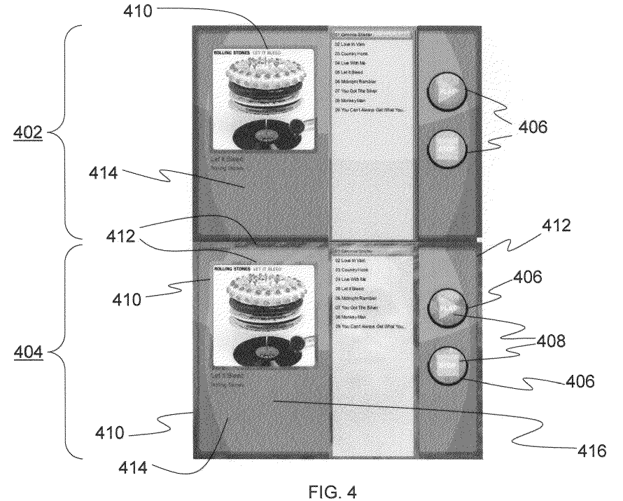

In another embodiment of the inventive concept, as shown in FIG. 4, a media player application GUI is illustrated with a first, non-reflective GUI 402 and a second, reflective user interface 404 applied. In the shown embodiment, buttons 406 show glass surface-type reflective effects 408, window frames 410 show distorted reflective effects 412, and the panel surface 414 of the GUI shows a faded, partially visible reflective effect 416.

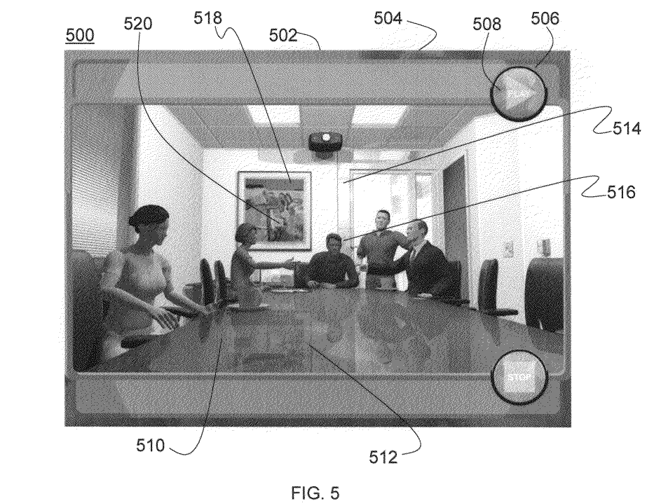

In yet another embodiment, as illustrated in FIG. 5, a 3D viewer application 500 is depicted. The frame 502 includes a distorted reflection effect 504, while the buttons 506 include mirror-like reflective effects 508. The conference table 510 also includes a mirror-like reflective effect 512 of the user. Additional reflective effects include a reflective effect 516 on the metal door frame 514 and a reflective effect 520 on the glass of the painting 518.

In each embodiment, the naturalistic treatment of the user's reflection is central to the success of the application. This naturalistic treatment of reflections can be broken into four components: reverse image, opacity, scale and perspective.

A key component of the reflective effect is that the reflection of the user and environment is always reversed from the video images that are captured by the video capture device. Since a real-life reflection is always a reverse image, the reflective effect in the GUI should also be reversed.

Opacity is another factor in creating the reflective effect. Glossier, more reflective surfaces will have a more opaque reflection while more matte surfaces will allow more of their underlying color to show through a less opaque reflection. For example, the virtual mirror 310 will have a 100% opaque reflection 312 while the shiny metal surface of the door frame 514 will have a 30% opaque reflection 516. If the opacity of the reflections is not varied according to their simulated surface material, the reflective effect is diminished and the reflections begin to appear less realistic and more like a video overlay. The opacity changes in the reflections don't need to be perfectly accurate to provide a realistic look to a user; they simply have to be guided by the underlying “virtual” materials.

Scaling the reflective effect permits the perception of depth between objects in the GUI. An object below another object in the UI will have its reflections scaled down when compared to reflections in an object above it. All of the UI examples discussed herein make use of scaled reflections. The scaled reflections provide a subtle sense of depth, separating foreground elements from the background layer of the UI. This effect is, perhaps, most obvious in the 3D example of FIG. 5, where the reflection 520 on the painting's surface 518 in the back of the 3D rendering of a conference room is much smaller than the reflection 512 on the conference table 510 in the foreground. If the scale of the reflections is not varied accordingly the reflection effect is significantly diminished, the reflections appear much less realistic and more like a video overlay. Again, the scaling in the reflections doesn't need to be perfectly accurate to provide a realistic look to a user; they simply have to be guided by the underlying “virtual” materials.

Perspective is another component of properly representing reflections in the GUI. The simulated reflection must be distorted to account for any simulated 3D shapes in the GUI, such as the buttons 302 in FIG. 3. As with opacity and scaling components, the perspective distortion doesn't need to be perfectly accurate; it simply has to be guided by the underlying shape.

Blurriness is another potential component of these simulated reflections. Unless the user is looking at a mirrored surface, no surface will create a perfect reflection. Depending on the type of material, the reflection may be somewhat blurry. In addition to the manipulations above, adding a blurred effect to the overall reflective effect also increases the naturalistic look of the reflection. The blurriness component is further evidence that the use of the components above—opacity, scaling and perspective—does not need to be perfectly accurate, as a user expects a reflective image to be imperfect in many ways.

As noted in each of the components of a naturalistic reflection, perfect accuracy is not necessary to achieve satisfactory results. In much the same way that current user interfaces abstract 3D shapes and materials in order to produce a more useful user interface, reflections also need to be carefully orchestrated. In one embodiment, the reflective effect is manipulated to enhance the overall usability of the GUI even if the manipulation requires degrading the accuracy of the reflections. This abstraction enhances the usability of the GUI by preventing visual clutter. These manipulations of the reflected image also mask the inherent limitation of using a camera to generate an accurate reflected image. By manipulating the user's reflection over time it is possible to draw their attention to specific areas of the screen. For example, an important dialog box could reflect their image more strongly.

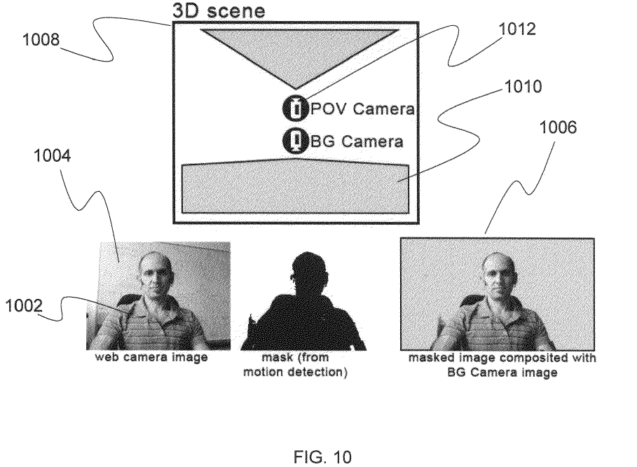

In one embodiment, a video of the user and surrounding environment is manipulated to appear as a naturalistic reflection in a two dimensional (“2D”) or 3D computer generated user interface. The video can be captured by a camera or similar video capture device. The user's surrounding environment may be enhanced or replaced in the final composite reflective effect, as shown in FIG. 10 (discussed below). In one embodiment, one or more instances of the video are manipulated and overlaid onto a GUI. The video can also be projected onto the GUI using texture mapping. In an additional embodiment, the video is imported into the background of a scene and reflected into the foreground GUI using a 3D graphics engine with the ability to support such a reflection. In such an embodiment the video can be attached to one or more objects as a texture map or projected onto one or more objects from a virtual light source.

In an additional embodiment, the reflective user interface is a traditional window, icon, menu, pointing device (“WIMP”) interface, a 3D scene or other design displayed on a computer monitor. The reflective user interface may also be projected onto a surface, such as a reflective screen or rear projection screen, or even viewed using a stereoscopic device such as a helmet or goggles.

The reflective user interface may also be designed so that multiple users may perceive the same GUI differently. On one level unique perception by multiple users is a given, as the UI incorporating the users' reflection (and the reflection of their immediate surroundings) will appear different to everyone. In virtual spaces where the user is represented as an avatar and all other users are represented as avatars, each participant's perception of the shared scene will be different. This is true when the rendering of the shared scene is handled locally, as is the case in most virtual environments (e.g. SecondLife, Qwaq, and World of Warcraft).

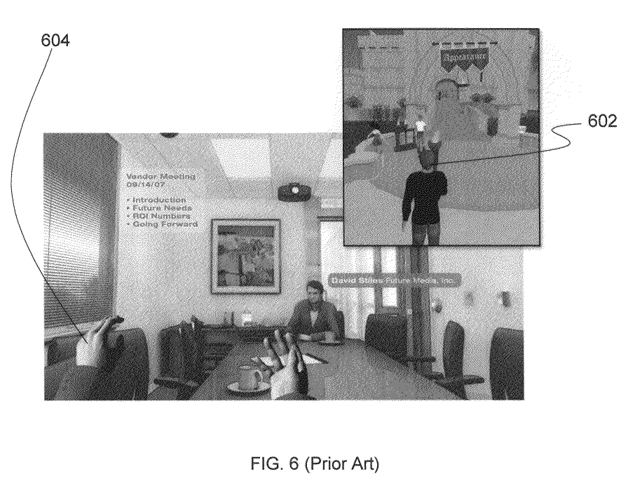

The inventive reflective user interface has significant potential for 3D interfaces such as virtual reality interactions shown in FIG. 6. Typically users are given a sense of presence in 3D environments via an avatar. In Point Of View (“POV”) interfaces such as that depicted in FIG. 6, they typically see either see the back of their avatar's head 602 or disembodied arms 604 that originate at the bottom of the screen. The reflective 3D interface reduces or eliminates the need for the user to be represented as an avatar for the purpose of giving the user a sense of presence in virtual space. This more natural representation of the user enhances their experience in the virtual environment. They are no longer observing themselves in the virtual environment, but become more immersed into it.

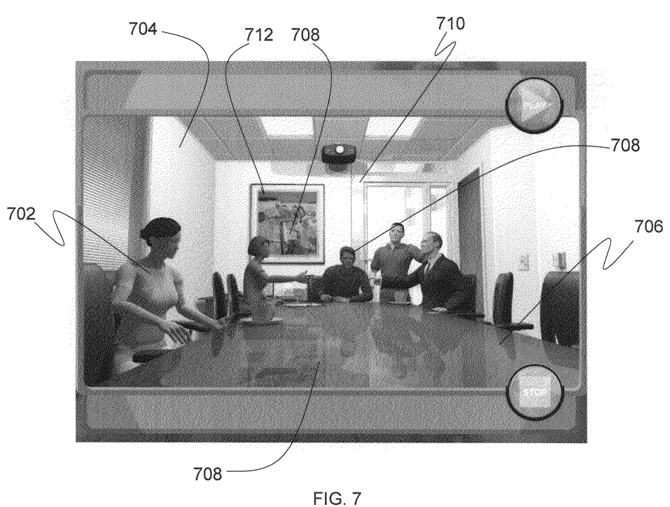

In the embodiment described in FIG. 7, a static 3D viewer (one in which the user's point of view does not change) is the basis for a hybrid reality communication tool. The user is given a sense of presence in the hybrid environment via the inclusion of their naturalistic reflection on various surfaces. Other users 702 are depicted as avatars. All participants in this environment have a similar experience; they see themselves reflected in the virtual space and they see all other participants depicted as avatars. The user participates in a virtual conference with 3D depictions of a conference room 704, conference table 706 and the other users 702. To provide the user with a sense of actually being in the conference room, the reflective effect is implemented onto many surfaces in the image, including the reflective effects 708 on the conference table, door frame 710 and painting 712.

Since all users of this system perceive a different fourth wall (in this case the wall that is physically behind the user), this space appears logical to each individual user even though its global structure is non Euclidean. In one potential embodiment, a 3D communication model allows different users to communicate. Finally, methods for controlling the avatars are also possible, as known in the field of the art.

In one embodiment, the effects causing the incoming video image to look like natural reflections can be modified over time to allow for some limited “camera motion” (e.g. panning across the scene).

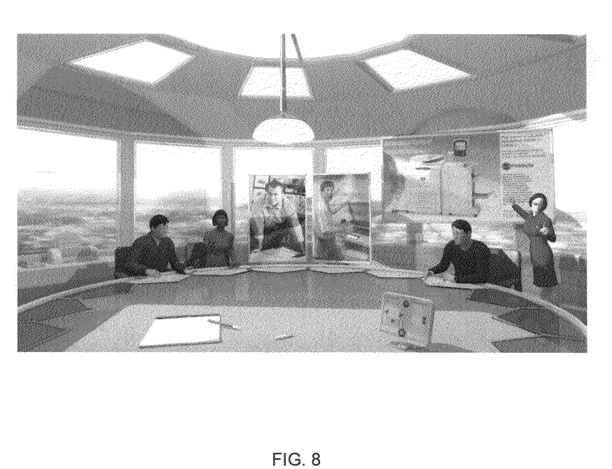

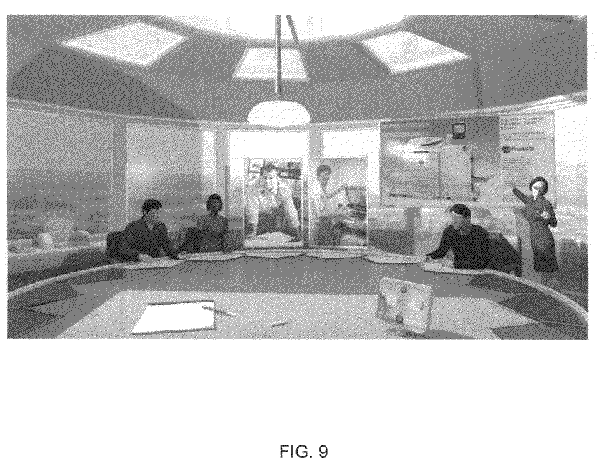

A much less static version of the 3D viewer is also possible. In this embodiment, the reflections are simulated via projective texture mapping of the incoming video signal or by some other method that is supported by a 3D rendering engine. See Projective Texture Mapping, Cass Everitt, NVIDIA, http://developer.nvidia.com/view.asp?IO=Projective—Texture—Mapping, 2001. A simulation of the projective mapping effect, as illustrated in FIG. 8, reveals unique features as well as some limitations. The edge of the video image must be extended in proportion to the field of view of the virtual camera (in the 3D space) in order to create a convincing reflection. If the image is simply scaled the reflections seems out of scale with the scene. One method for doing this is to simply stretch the edges of the video image, as illustrated in FIG. 9. As illustrated in FIG. 10, the user's image 1002 can also be extracted from their environment 1004 and placed into a new environment. A composite image 1006 is then projected into the 3D scene 1008. Foreground/background extraction techniques will produce a crude composite. If the reflections have a low enough alpha (if they are very light) this will be adequate since much detail is lost in this situation anyway. If higher alpha reflections are desired, chroma-key techniques are required.

The background plate used for the composite can include:
1) a separate wide-angle view of the user's surroundings captured by a different camera
2) a non related image (e.g. a beach scene, city skyline, or artwork)
3) a reverse angle view of the 3D scene captured by a virtual camera located in the 3D space

Many 3D environments, Open GL for example, allow for fairly natural reflections. To take advantage of this, the user's image 1002, modified in much the same way as described above, would be mapped to a large plane 1010 that is behind a POV camera 1012 (in the 3D space). This method would yield the most realistic effect, although it is more processor intensive.

Virtual Reality systems like VirtuSphere are designed to immerse the user in a synthetic environment as completely as possible (VirtuSphere; Redmond, Wash.; http://www.virtusphere.com). In these systems a 3D environment is displayed stereoscopically via a helmet that is worn by a user. The inclusion of reflective effects in such a system would greatly enhance the feeling of total immersion that is sought by the makers and users of such systems. This is true for both entertainment and training simulators. Reflections, whether they are derived from a single user or a group will greatly enhance the sense of reality and unpredictability of a simulation. For groups of users (where the spheres are networked together), this effect would enhance their sense of community by enhancing their social presence as described in the Social Presence Theory (Short et al., 1976). This might be particularly useful for military or law enforcement training simulators.

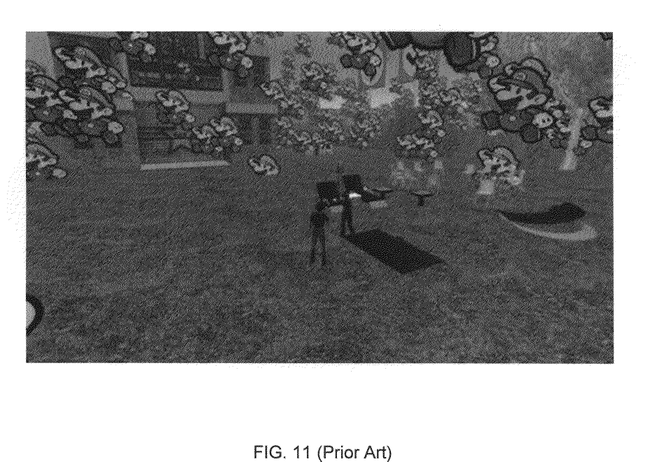

This above-described method may also influence a user's behavior. Currently “griefing”, or purposely causing significant disruptions in a 3D environment, is a common occurrence. These disturbances can be offensive, silly or both as in the ‘Super Mario’ barrage illustrated in FIG. 11. In some cases these disturbances crash the systems hosting the 3D environment. Simply presenting a set of eyes may influence users to behave better. Increased “presence” and feelings of empathy may also positively influence behavior. Just knowing that the system is recording images may also influence behavior. Griefing is done by persons who wish to keep their real identities secret even while they draw attention to their “online” or virtual characters.

By specifically manipulating a virtual reflection of the user and then incorporating it onto a graphical user interface, this system provides a novel method for increasing a graphical user interface's visual appeal and ability to provide useful feedback. Users are given an enhanced sense of ownership and presence.

Real-time video analysis may well prove to be an important feature in future reflective user interface designs. By incorporating these or other motion tracking it may be possible to create a UI that incorporates human computer interactions that are more natural than those supported by the traditional keyboard mouse setup. In some current embodiments, no decisions are made by the system based upon the images it captures. The video is simply captured and then processed in order to render predefined effects. In other embodiments, image analysis allows, in one example, the determination of where the dominant light source is in a user's environment, which is used to cast “virtual” shadows and create virtual highlights.

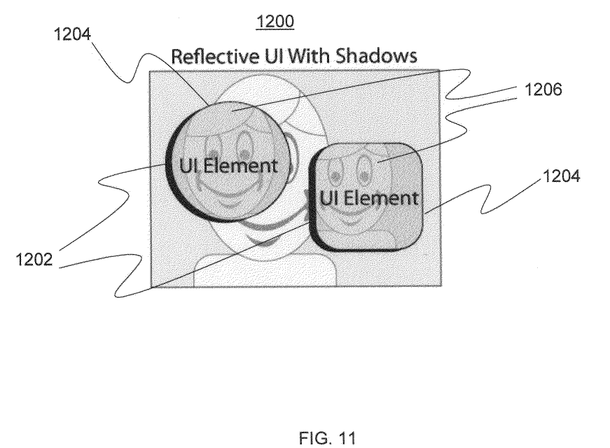

The reflective user interface may further include the portrayal of a shadow effect in various aspects of the GUI. The shadows are depicted on the elements of the GUI such as windows, buttons, etc., to simulate a shadow being cast behind the GUI elements. FIG. 12 illustrates one embodiment of a reflective user interface 1200 where shadows 1202 are depicted on the GUI elements 1204 in addition to the reflective effects 1206.

In another embodiment, dynamic shadow effects and highlight effects may be implemented into the reflective user interface by identifying the location of a light source or the brightest spot in the surrounding environment and creating shadows and highlights in the reflective user interface that correspond to the brightest spot. This embodiment generates shadows and highlights by analyzing the incoming video stream (the same stream that is used to generate the reflections). The stream is divided into a grid with numerous segments, where each segment of the grid is constantly polled. Each segment votes as to whether or not it (the segment) is bright enough to cast a shadow. Once all of the cells are polled, their votes are tallied and the virtual shadows are displaced from the objects casting them by the amount arrived at in the tally. The highlights are rotated around the center of the objects that are casting the shadows so that they “point” away from the center of the newly cast shadow. When no shadows are cast (i.e. there isn't a strong light source) then the alpha value of the shadows and reflections is zero.

The method for calculating the light source described above is designed to require the minimum processing to achieve an effective shadow or highlight effect. One skilled in the art will appreciate that there are numerous methods for detecting the light source which vary in computational requirements and degree of error. However, the method described above produces an effective shadow and highlight effect with minimal computation time and an acceptable degree of error that is well suited for the applications described herein.

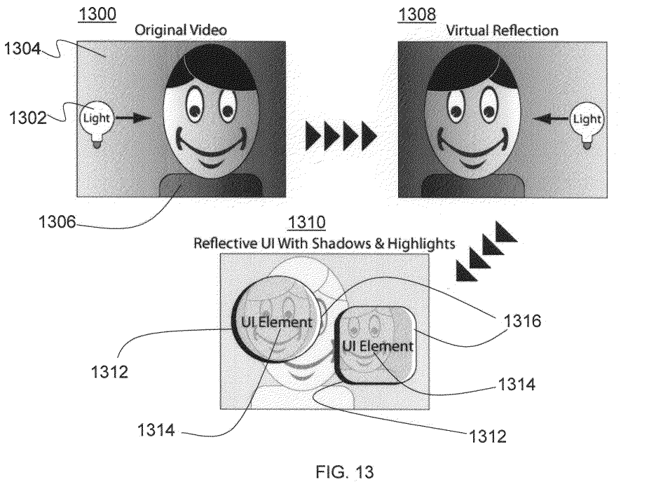

In one illustration shown in FIG. 13, the original video 1300 includes a light source 1302 that is located in the surrounding environment 1304 in the proximity of the user 1306. The system manipulates the video images to reverse the image and correctly orient the reflection image 1308 that will be used to create the reflective effect. The video signal is processed with density mapping to determine the darkest and lightest areas of the reflection image 1308. The system will then create a reflective user interface 1310 that includes shadows 1312 along particular edges of the GUI elements 1314, such that the location of the shadows 1312 correspond to the opposite location where the light source 1302 is positioned in the reflection image 1308. In addition, the GUI elements 1314 near the light source 1302 may have highlight effects 1316, where the GUI elements 1314 become brighter along edges facing the light source 1302. Instead of head or eye tracking, signal processing and density mapping are used to create this shadow effect that is more realistic to the user. However, signal processing is processor intensive and could affect the performance an application making use of the reflective user interface. To keep from sacrificing the performance of the overall reflective user interface, the accuracy of the shadow can be decreased to reduce the level of computational power required to “cast” the shadows.

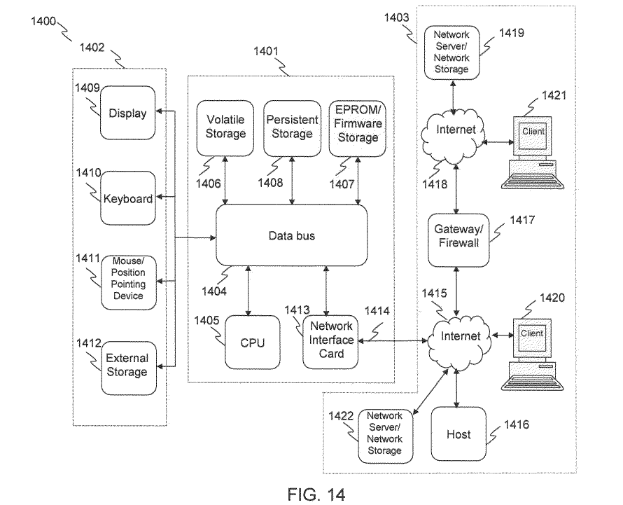

FIG. 14 is a block diagram that illustrates an embodiment of a computer/server system 1400 upon which an embodiment of the inventive methodology may be implemented. The system 1400 includes a computer/server platform 1401, peripheral devices 1402 and network resources 1403.

The computer platform 1401 may include a data bus 1404 or other communication mechanism for communicating information across and among various parts of the computer platform 1401, and a processor 1405 coupled with bus 1401 for processing information and performing other computational and control tasks. Computer platform 1401 also includes a volatile storage 1406, such as a random access memory (RAM) or other dynamic storage device, coupled to bus 1404 for storing various information as well as instructions to be executed by processor 1405. The volatile storage 1406 also may be used for storing temporary variables or other intermediate information during execution of instructions by processor 1405. Computer platform 1401 may further include a read only memory (ROM or EPROM) 1407 or other static storage device coupled to bus 1404 for storing static information and instructions for processor 1405, such as basic input-output system (BIOS), as well as various system configuration parameters. A persistent storage device 1408, such as a magnetic disk, optical disk, or solid-state flash memory device is provided and coupled to bus 1401 for storing information and instructions.

Computer platform 1401 may be coupled via bus 1404 to a display 1409, such as a cathode ray tube (CRT), plasma display, or a liquid crystal display (LCD), for displaying information to a system administrator or user of the computer platform 1401. An input device 1420, including alphanumeric and other keys, is coupled to bus 1401 for communicating information and command selections to processor 1405. Another type of user input device is cursor control device 1411, such as a mouse, a trackball, or cursor direction keys for communicating direction information and command selections to processor 1404 and for controlling cursor movement on display 1409. This input device typically has two degrees of freedom in two axes, a first axis (e.g., x) and a second axis (e.g., y), that allows the device to specify positions in a plane.

An external storage device 1412 may be connected to the computer platform 1401 via bus 1404 to provide an extra or removable storage capacity for the computer platform 1401. In an embodiment of the computer system 1400, the external removable storage device 1412 may be used to facilitate exchange of data with other computer systems.

The invention is related to the use of computer system 1400 for implementing the techniques described herein. In an embodiment, the inventive system may reside on a machine such as computer platform 1401. According to one embodiment of the invention, the techniques described herein are performed by computer system 1400 in response to processor 1405 executing one or more sequences of one or more instructions contained in the volatile memory 1406. Such instructions may be read into volatile memory 1406 from another computer-readable medium, such as persistent storage device 1408. Execution of the sequences of instructions contained in the volatile memory 1406 causes processor 1405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1405 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1408. Volatile media includes dynamic memory, such as volatile storage 1406. Transmission media includes coaxial cables, copper wire and fiber optics, including the wires that comprise data bus 1404. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1405 for execution. For example, the instructions may initially be carried on a magnetic disk from a remote computer. Alternatively, a remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on the data bus 1404. The bus 1404 carries the data to the volatile storage 1406, from which processor 1405 retrieves and executes the instructions. The instructions received by the volatile memory 1406 may optionally be stored on persistent storage device 1408 either before or after execution by processor 1405. The instructions may also be downloaded into the computer platform 1401 via Internet using a variety of network data communication protocols well known in the art.

The computer platform 1401 also includes a communication interface, such as network interface card 1413 coupled to the data bus 1404. Communication interface 1413 provides a two-way data communication coupling to a network link 1414 that is connected to a local network 1415. For example, communication interface 1413 may be an integrated services digital network (ISDN) card or a modem to provide a data communication connection to a corresponding type of telephone line. As another example, communication interface 1413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1413 sends and receives electrical, electromagnetic or optical signals that carry digital data streams representing various types of information.

Network link 1413 typically provides data communication through one or more networks to other network resources. For example, network link 1414 may provide a connection through local network 1415 to a host computer 1416, or a network storage/server 1417. Additionally or alternatively, the network link 1413 may connect through gateway/firewall 1417 to the wide-area or global network 1418, such as an Internet. Thus, the computer platform 1401 can access network resources located anywhere on the Internet 1418, such as a remote network storage/server 1419. On the other hand, the computer platform 1401 may also be accessed by clients located anywhere on the local area network 1415 and/or the Internet 1418. The network clients 1420 and 1421 may themselves be implemented based on the computer platform similar to the platform 1401.

Local network 1415 and the Internet 1418 both use electrical, electromagnetic or optical signals that carry digital data streams. The signals through the various networks and the signals on network link 1414 and through communication interface 1413, which carry the digital data to and from computer platform 1401, are exemplary forms of carrier waves transporting the information.

Computer platform 1401 can send messages and receive data, including program code, through the variety of network(s) including Internet 1418 and LAN 1415, network link 1414 and communication interface 1413. In the Internet example, when the system 1401 acts as a network server, it might transmit a requested code or data for an application program running on client(s) 1420 and/or 1421 through Internet 1418, gateway/firewall 1417, local area network 1415 and communication interface 1413. Similarly, it may receive code from other network resources.

The received code may be executed by processor 1405 as it is received, and/or stored in persistent or volatile storage devices 1408 and 1406, respectively, or other non-volatile storage for later execution. In this manner, computer system 1401 may obtain application code in the form of a carrier wave.

Various aspects of the present invention, whether alone or in combination with other aspects of the invention, may be implemented in C++ code running on a computing platform operating in a Windows XP environment. However, aspects of the invention provided herein may be implemented in other programming languages adapted to operate in other operating system environments. Further, methodologies may be implemented in any type of computing platform, including but not limited to, personal computers, mini-computers, main-frames, workstations, networked or distributed computing environments, computer platforms separate, integral to, or in communication with charged particle tools, and the like. Further, aspects of the present invention may be implemented in machine readable code provided in any memory medium, whether removable or integral to the computing platform, such as a hard disc, optical read and/or write storage mediums, RAM, ROM, and the like. Moreover, machine readable code, or portions thereof, may be transmitted over a wired or wireless network.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, per, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in a user interface with one or more of the inventive functions. It is intended that all matter contained in the above description or shown in the accompanying drawings shall be interpreted as illustrative only and not limiting.

What is claimed is:

1. A system for incorporating a real-time reflection of a user and surrounding environment into a graphical user interface (“GUI”), the system comprising:
a video capture device for capturing a video of a user and surrounding environment in real-time;
a processing module operable to receive the video from the video capture device and manipulate the video to create a reflective effect; the processing module being further operable to cause the reflective effect to be incorporated into at least one element of the GUI to create a reflective user interface; and
a display operable to display the reflective user interface to the user in real-time, wherein at least a portion of the reflective effect is shown to the user.

2. The system of claim 1, wherein the video capture device is a camera.

3. The system of claim 2, wherein the processing module is a computer system comprising a memory operable to store computer-readable instructions and a processor module operable to execute the computer-readable instructions.

4. The system of claim 1, wherein the processing module is further operable to manipulate the video by altering the opacity of the video.

5. The system of claim 1, wherein the processing module is further operable to manipulate the video by altering scale of the video.

6. The system of claim 1, wherein the processing module is further operable to manipulate the video by altering orientation of the video.

7. The system of claim 6, wherein the processing module is further operable to alter the orientation of the video by reversing the video image.

8. The system of claim 1, wherein the processing module is further operable to manipulate the video by degrading quality of the video.

9. The system of claim 8, wherein the processing module is further operable to degrade the quality of the video by blurring the video.

10. The system of claim 1, wherein the processing module is further operable to incorporate the reflective effect into the at least one element of the GUI by overlaying the video onto the GUI using texture mapping.

11. The system of claim 1, wherein the at least one element of the GUI comprises a window, a frame, a button or an icon.

12. The system of claim 1, wherein the processing module is further operable to alter the reflective effect to simulate a reflection from a type of material depicted in the GUI.

13. The system of claim 1, wherein the processing module is further operable to alter the reflective effect to simulate a reflection from a shape of the at least one element of the GUI.

14. The system of claim 1, wherein the processing module is further operable to remove and replace the surrounding environment.

15. The system of claim 1, wherein the processing module is further operable to incorporate the reflective user interface into a three-dimensional (“3D”) environment.

16. The system of claim 15, wherein the processing module is further operable to import the video into the background of a scene and reflect the video into the foreground using a 3D graphics engine.

17. The system of claim 1, wherein the display comprises a computer monitor.

18. The system of claim 1, wherein the graphical user interface comprises a window, an icon, a menu, or a pointing device (“WIMP”) interface.

19. The system of claim 1, wherein the graphical user interface comprises a 3D representation of a scene.

20. The system of claim 19, wherein the display is further operable to display the reflective user interface to a plurality of users, wherein each of the plurality of users perceives the reflective user interface differently.

21. The system of claim 1, wherein the processing module is operable to create a reflective user interface by incorporating a shadow effect into the at least one element of the GUI.

22. The system of claim 21, wherein the shadow effect is created by identifying a light source in the surrounding environment.

23. The system of claim 1, wherein the processing module is operable to create a reflective user interface by incorporating a highlight effect into the at least one element of the GUI.

24. The system of claim 23, wherein the processing module is further operable to incorporate the highlight effect by identifying a light source in the surrounding environment.

25. A method for incorporating a real-time reflection of a user and surrounding environment into a graphical user interface (“GUI”), the method comprising:
capturing a video of a user and surrounding environment in real-time;
receiving the video from the video capture device;
manipulating the video to create a reflective effect;
incorporating the reflective effect into at least one element of the GUI to create a reflective user interface; and
displaying the reflective user interface to the user in real-time, wherein at least a portion of the reflective effect is shown to the user.

26. The method of claim 25, wherein the reflective effect is created by degrading a quality of the video.

27. The method of claim 25, wherein the reflective effect is incorporated into a frame, a button or an icon of the GUI.

28. The method of claim 25, wherein the reflective effect is created by incorporating a shadow effect into the at least one element of the GUI.

29. A computer programming product embodied on a computer readable medium and comprising a set of computer-readable instructions for incorporating a real-time reflection of a user and a surrounding environment into a graphical user interface (“GUI”), the set of computer-readable instructions, when executed by one or more processors is operable to cause the one or more processors to::
receive a video signal of a user and surrounding environment in real-time;
manipulate the video to create a reflective effect;
incorporate the reflective effect into at least one element of the GUI; and
generate a reflective user interface using the incorporated reflective effects.

30. The computer programming product of claim 29, wherein the reflective effect is created by degrading a quality of the video.

31. The computer programming product of claim 29, wherein the reflective effect is incorporated into a frame, a button or an icon of the GUI.

32. The computer programming product of claim 29, wherein the reflective user interface is created by incorporating a shadow effect into the at least one element of the GUI.
